(19) United States
(12) Patent Application Publication
(10) Pub. No.: US 2026/0269273 A1
(43) Pub. Date: Sep. 10, 2026

(54) ANODELESS LITHIUM SECONDARY BATTERY USING SINTERED BODY OF AMORPHOUS ALLOY POWDER OR METALLIC GLASS POWDER, LITHIUM METAL SECONDARY BATTERY, AND METHOD FOR MANUFACTURING SAME

(71) Applicant: KOREA UNIVERSITY OF TECHNOLOGY AND EDUCATION INDUSTRY-UNIVERSITY COOPERATION FOUNDATION, Cheonan-si, Chungcheongnam-do (KR)

(72) Inventors: Suk Jun KIM, Cheonan-si, Chungcheongnam-do (KR); Tae Yang KIM, Gwangju (KR); Chae Yoon IM, Goyang-si, Gyeonggi-do (KR)

(21) Appl. No.: 19/480,018

(22) PCT Filed: Aug. 22, 2023
(86) PCT No.: PCT/KR2023/012431

§ 371 Date: Oct. 29, 2025

(30) Foreign Application Priority Data
Aug. 8, 2023 (KR) 10-2023-0103727

(51) Int. Cl. H01M 4/66; H01M 4/04; H01M 10/052

(52) U.S. Cl. CPC H01M 4/664; H01M 4/0471; H01M 4/662; H01M 10/052

(57) ABSTRACT

In order to improve the coulombic efficiency, electric capacity, and the like of an anode current collector, the present invention provides an anodeless lithium secondary battery using a sintered body of a mixture of an amorphous alloy powder or metallic glass powder and a non-metallic powder, or an anodeless lithium secondary battery comprising a current collector made of a sintered body of a mixture of an amorphous alloy powder or metallic glass powder containing two or more elements.

### TECHNICAL FIELD

The disclosure relates to an anodeless lithium secondary battery using a sintered body of amorphous alloy powder or metallic glass powder, a lithium metal secondary battery, and a method of manufacturing an anodeless lithium secondary battery using a sintered body of amorphous alloy powder or metallic glass powder. More specifically, the disclosure relates to an anodeless lithium secondary battery using a sintered body of a mixture of amorphous alloy powder or metallic glass powder and non-metallic powder and a method of manufacturing the same, and to an anodeless lithium secondary battery using a sintered body of amorphous alloy powder or metallic glass powder and a method of manufacturing the same. The disclosure relates to a lithium metal secondary battery including a lithium metal anode in which lithium metal is filled in void spaces of a sintered body of a mixture of amorphous alloy powder or metallic glass powder and non-metallic powder, and to a lithium metal secondary battery including a lithium metal anode in which lithium metal is filled in void spaces of a sintered body of amorphous alloy powder or metallic glass powder.

### BACKGROUND ART

A current collector of a lithium secondary battery serves as a transmitter that collects electrons generated as a result of an electrochemical reaction in an active material and flows the electrons to an external circuit, or serves as an intermediate pathway for supplying electrons provided from an external circuit to an electrode active material. In addition, a current collector is an important material for implementing the actual electrode plate shape. Considering electronic conductivity, electrochemical stability, and electrode plate manufacturing processes, metallic materials are mostly used as materials for current collectors. Since a current collector cannot have sufficient mechanical strength if its thickness is too thin, it is typically based on a thickness of about 10 to 20 μm. In addition, the surface condition of the current collector has an important effect on slurry coating, and the current collector must have good wettability with the electrode slurry, and the bonding between the binder and the current collector must have sufficient strength even after the solvent is volatilized.

Copper is mainly used as an anode current collector for lithium secondary batteries. This is because metals that are electrochemically inactive in the operating range of carbon electrodes are nickel and copper. However, in the case of nickel, it is not commonly used because it is expensive, and copper, which is relatively inexpensive, is widely used.

Therefore, more research is needed on methods that can improve the coulombic efficiency, electrical capacity, and the like of anode current collectors using copper or nickel.

### DETAILED DESCRIPTION OF INVENTION

### Problems to be Solved

The disclosure is intended to solve the above-described problems, and aims to provide an anodeless lithium secondary battery including a current collector manufactured from a sintered body of a mixture of amorphous alloy powder or metallic glass powder and non-metallic powder, or a current collector manufactured from a sintered body of two or more types of amorphous alloy powder or metallic glass powder, in order to improve the coulombic efficiency, electrical capacity, and the like of an anode current collector.

In addition, the disclosure aims to provide a lithium metal secondary battery including a lithium metal anode in which lithium metal is filled in void spaces of a sintered body of a mixture of amorphous alloy powder or metallic glass powder and non-metallic powder, or a sintered body of a mixture of two or more types of amorphous alloy powder or metallic glass powder.

### Solution to Solve the Problems

To achieve the above-described objective, an anodeless lithium secondary battery according to a first embodiment of the disclosure includes a cathode, an anode current collector positioned facing the cathode and manufactured by sintering a mixture of amorphous alloy powder or metallic glass powder and non-metallic powder, an electrolyte positioned between the cathode and the anode current collector, and a separator separating the cathode and the current collector.

In addition, an anodeless lithium secondary battery according to a second embodiment of the disclosure includes a cathode, an anode current collector positioned facing the cathode and manufactured by sintering a mixture of amorphous alloy powder or metallic glass powder, an electrolyte positioned between the cathode and the current collector, and a separator separating the cathode and the anode current collector.

In addition, a lithium metal secondary battery according to a third embodiment of the disclosure includes a cathode, a lithium metal anode positioned facing the cathode, in which lithium metal is filled in void spaces of a sintered body of a mixture of amorphous alloy powder or metallic glass powder and non-metallic powder, an electrolyte positioned between the cathode and the lithium metal anode, and a separator separating the cathode and the lithium metal anode.

In addition, a lithium metal secondary battery according to a fourth embodiment of the disclosure includes a cathode, a lithium metal anode positioned facing the cathode, in which lithium metal is filled in void spaces of a sintered body of a mixture of amorphous alloy powder or metallic glass powder, an electrolyte positioned between the cathode and the lithium metal anode, and a separator separating the cathode and the lithium metal anode.

In the first to fourth embodiments, the electrolyte is characterized as being a liquid electrolyte or a solid electrolyte.

In addition, a method of manufacturing an anodeless lithium secondary battery according to a fifth embodiment of the disclosure includes a first step of preparing a paste containing amorphous alloy powder or metallic glass powder and non-metallic powder, a second step of printing the paste of the first step on a substrate using a screen mask pattern, a third step of obtaining a sintered body by heat-treating the paste of the second step, and a fourth step of separating the sintered body obtained in the third step from the substrate. Here, the second step involves printing the paste mixed in the first step using a squeegee. In the third step, the material printed in the second step is placed in a rapid thermal process (RTP) equipment, purged in an Ar atmosphere, and then heat-treated while flowing Ar gas.

In addition, a method of manufacturing an anodeless lithium secondary battery according to a sixth embodiment of the disclosure includes a first step of preparing a paste containing amorphous alloy powder or metallic glass powder, a second step of printing the paste of the first step on a substrate using a screen mask pattern, a third step of obtaining a sintered body by heat-treating the paste of the second step, and a fourth step of separating the sintered body obtained in the third step from the substrate. Here, the second step involves printing the paste mixed in the first step using a squeegee. In the third step, the material printed in the second step is placed in an RTP equipment, purged in an Ar atmosphere, and then heat-treated while flowing Ar gas.

In the disclosure, to manufacture a current collector or lithium metal anode, a mixture of two or more types of amorphous alloy powder or two or more types of metallic glass powder and non-metallic powder is sintered and used, or a mixture of two or more types of amorphous alloy powder or two or more types of metallic glass powder is sintered and used.

The metallic glass powder includes at least two or more different elements. Here, the metallic glass powder includes components represented by Formula 1 below.

$${( Am 1 )}_{n 1} + {( Am 2 )}_{n 2} + {( Am 3 )}_{n 3} + … + {( Amx )}_{ny} \qquad ( Formula 1 )$$

Here, Am1, Am2, Am3, . . . , Amx represent different metallic glass elements, x is an integer of 2 or more, more preferably x is an integer from 2 to 30, y is an integer from 2 to 30, and n1>0, n2>0, n3≥0, . . . , ny≥0 and n1+n2+ . . . +ny=100 are satisfied.

For example, when the metallic glass consists of two elements, it is represented by Formula 1-1 below.

$${( Am 1 )}_{n 1} + {( Am 2 )}_{n 2} \qquad ( Formula 1 - 1 )$$

Here, Am1 and Am2 represent different metallic glass elements, and n1>0, n2>0, n3=0, . . . , ny=0 and n1+n2=100 are satisfied.

Alternatively, when the metallic glass consists of four elements, it is represented by Formula 1-2 below.

$${( Am 1 )}_{n 1} + {( Am 2 )}_{n 2} + {( Am 3 )}_{n 3} + {( Am 4 )}_{n 4} \qquad ( Formula 1 - 2 )$$

Here, Am1, Am2, Am3, Am4 represent different metallic glass elements, and n1>0, n2>0, n3>0, n4>0, n5=0, . . . , ny=0 and n1+n2+n3+n4=100 are satisfied.

The metallic glass powder containing the components represented by Formula 1 satisfies enthalpy relationship of Formula 2 below, and when ΔHₜₒₜₐₗ≥0, the amorphous alloy powder or metallic glass powder more easily undergoes a phase transformation to crystalline form during the manufacturing process of the amorphous alloy powder or metallic glass powder, thus the effects of the disclosure cannot be obtained.

$$Δ {H}_{total} = Δ {H}_{12} + Δ {H}_{13} + Δ {H}_{14} + … + Δ {H}_{1 x} + Δ {H}_{23} + Δ {H}_{24} + … + Δ {H}_{2 x} + Δ {H}_{34} + … + Δ {H}_{3 x} + … + Δ {H}_{( x - 1 ) x} < 0 \qquad ( Formula 2 )$$

Here, ΔH₍ₓ₋₁₎ₓ represents mixing enthalpy of the Am(x-1) element and the Am(x) element. For example, in Formula 2, the mixing enthalpy of elements is defined as follows.

ΔH₁₂: Mixing enthalpy of Am1 element and Am2 element

ΔH₁₃: Mixing enthalpy of Am1 element and Am3 element

ΔH₁₄: Mixing enthalpy of Am1 element and Am4 element

ΔH₁ₓ: Mixing enthalpy of Am1 element and Amx element

ΔH₂₃: Mixing enthalpy of Am2 element and Am3 element

ΔH₂₄: Mixing enthalpy of Am2 element and Am4 element

ΔH₂ₓ: Mixing enthalpy of Am2 element and Amx element

ΔH₃₄: Mixing enthalpy of Am3 element and Am4 element

ΔH₃ₓ: Mixing enthalpy of Am3 element and Amx element

For example, when the metallic glass powder consists of three elements, it is represented by Formula 2-1 below.

$$Δ {H}_{total} = Δ {H}_{12} + Δ {H}_{13} + Δ {H}_{23} < 0 \qquad ( Formula 2 - 1 )$$

The metallic glass powder is characterized as being a mixture of two or more types selected from lanthanum (La), cerium (Ce), praseodymium (Pr), promethium (Pm), samarium (Sm), lutetium (Lu), yttrium (Y), neodymium (Nd), gadolinium (Gd), terbium (Tb), dysprosium (Dy), holmium (Ho), erbium (Er), thulium (Tm), thorium (Th), calcium (Ca), scandium (Sc), barium (Ba), beryllium (Be), bismuth (Bi), rubidium (Rb), germanium (Ge), lead (Pb), ytterbium (Yb), chromium (Cr), strontium (Sr), europium (Eu), zirconium (Zr), thallium (Tl), lithium (Li), hafnium (Hf), magnesium (Mg), phosphorus (P), arsenic (As), iron (Fe), palladium (Pd), gold (Au), plutonium (Pu), cobalt (Co), gallium (Ga), tungsten (W), germanium (Ge), silver (Ag), sodium (Na), molybdenum (Mo), nickel (Ni), aluminum (Al), copper (Cu), zinc (Zn), antimony (Sb), silicon (Si), tin (Sn), titanium (Ti), cadmium (Cd), indium (In), platinum (Pt), and mercury (Hg) elements.

The glass transition temperature of the metallic glass powder is characterized as being 100° C. or higher.

The amorphous alloy powder is characterized as being selected from one or more of Li powder, Mg powder, Cu powder, Ni powder, Al powder, Ti powder, and Sn powder.

The non-metallic powder is characterized as being selected from one or more of graphite powder, ZrO₂ powder, lithium lanthanum zirconate oxide (LLZO) powder, and solid electrolyte powder. Here, ZrO₂ can be used in the form of Zr(OH)₄.

The size of the amorphous alloy powder or metallic glass powder may be 50 nm to 30 μm, and more preferably 500 nm to 20 μm may be used.

A paste containing the amorphous alloy powder or metallic glass powder may contain amorphous alloy powder or metallic glass powder and a solvent, and the weight ratio of the mixture of the amorphous alloy powder or metallic glass powder to the solvent may be 5 to 9.5:1.5 to 5.

A paste containing the amorphous alloy powder or metallic glass powder and graphite may contain amorphous alloy powder or metallic glass powder, graphite, and a solvent, and the weight ratio of the mixture of the amorphous alloy powder or metallic glass powder to graphite may be 60 to 95:5 to 40. In addition, the weight ratio of the mixture of the amorphous alloy powder or metallic glass powder and graphite to the solvent may be 5 to 9.5:1.5 to 5.

A paste containing Cu powder and Zr(OH)₄ of amorphous alloy powder or metallic glass powder may contain Cu powder, Zr(OH)₄, and a solvent, and the atomic percent (at %) ratio of Cu to Zr may be 90 to 99:1 to 10. The weight ratio of the mixture of the Cu powder and Zr(OH)₄ to the solvent may be 5 to 9.5:1.5 to 5.

A paste containing Cu powder, graphite, and Zr(OH)₄ of amorphous alloy powder or metallic glass powder may contain Cu powder, graphite, Zr(OH)₄, and a solvent, and the at % ratio of Cu and Zr may be 90 to 99:1 to 10. The mixture of the Cu powder and Zr(OH)₄ and graphite may be used at a weight ratio of 80 to 99:1 to 20. The weight ratio of the mixture of the Cu powder, graphite, and Zr(OH)₄ to the solvent may be 5 to 9.5:1.5 to 5.

A paste containing LLZO powder may contain LLZO powder and a solvent, and the weight ratio of LLZO powder to the solvent may be 3 to 30:7 to 70.

The solvent may be any one of methanol, ethanol, propanol, isopropanol, n-butanol, 2-butanol, isobutanol, tert-butanol, 2-ethoxyethanol, 2-butoxyethanol, 3-methoxypropanol, 1-methoxy-2-propanol, 1-ethoxy-2-propane, diacetone alcohol, acetone, methyl ethyl ketone, methyl isobutyl ketone, toluene, xylene, ethyl acetate, butyl acetate, polyethylene glycol, or a mixture thereof.

Obtaining a sintered body by heat-treating in the disclosure includes a step of vaporizing a solvent by performing heat treatment at a temperature of 200° C. to 300° C. for 1 minute to 10 minutes, and a step of sintering by performing heat treatment at a temperature of 500° C. to 1,000° C. for 1 minute to 10 minutes.

### Advantages of the Invention

As described above, the disclosure has an effect of improving the coulombic efficiency and electrical capacity of an anode current collector by using an anode current collector equipped with a sintered body of a mixture of amorphous alloy powder or metallic glass powder and non-metallic powder, or an anode current collector equipped with a sintered body of amorphous alloy powder or metallic glass powder.

### BRIEF DESCRIPTION OF DRAWINGS

FIG. 1 shows capacity relationship with cycles when charging and discharging are performed under 0.2 C (3.0 to 3.8 V cutoff) conditions using a composite of metallic glass powder of each of Zr—Cu—Ni—Al, Mo—Zr—Co—Si, Mo—Zr—Ti—Si, Ti—Cu—Ni—Zr, and Al—Ni—Y—Co, graphite 10 wt %, and Zr(OH)₄ 1 at % as an anode and lithium iron phosphate (LFP) as a cathode.

FIG. 2 is a scanning electron microscope (SEM) image before cycling for surface morphology analysis of an anode to which a composite of Mo—Zr—Co—Si metallic glass powder, graphite 10 wt %, Zr(OH)₄ 1 at % is applied, where FIG. 2A shows an SEM image of the anode surface, and FIG. 2B is an SEM image of the anode cross-section.

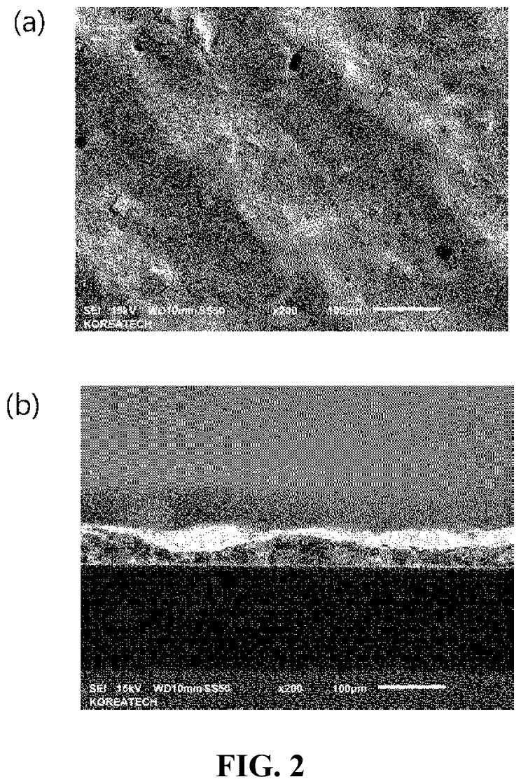

FIG. 3 shows a comparison of overpotentials measured at 0.1 mA cm⁻² current density with 0.5 mAh cm⁻² capacity for half-cells having anodes to which a composite of metallic glass powder of each of Zr—Cu—Ni—Al, Mo—Zr—Co—Si, Mo—Zr—Ti—Si, Ti—Cu—Ni—Zr, and Al—Ni—Y—Co, graphite 10 wt %, Zr(OH)₄ 1 at % is applied, compared with overpotentials measured under the same conditions for half-cells manufactured with copper foil.

### EMBODIMENTS FOR CARRYING OUT THE INVENTION

The disclosure may be subject to various modifications and may have various embodiments, and specific embodiments will be illustrated in the drawings and described in detail in the detailed description. However, this is not intended to limit the disclosure to specific embodiments, and should be understood to include all modifications, equivalents, and substitutes included in the spirit and technical scope of the disclosure. Similar reference numerals have been used for similar components while describing each drawing.

Terms such as first, second, A, B, and the like may be used to describe various components, but the components should not be limited by the terms. The terms are used only for the purpose of distinguishing one component from another component.

For example, without departing from the scope of rights of the disclosure, a first component may be named a second component, and similarly, a second component may also be named a first component. The term “and/or” includes a combination of a plurality of related listed items or any item among a plurality of related listed items.

When a component is referred to as being “connected” or “coupled” to another component, it should be understood that it may be directly connected or coupled to the other component, but other components may exist in between. On the other hand, when a component is referred to as being “directly connected” or “directly coupled” to another component, it should be understood that no other components exist in between.

The terms used in this application are used only to describe specific embodiments and are not intended to limit the disclosure. Singular expressions include plural expressions unless the context clearly indicates otherwise. In this application, terms such as “include” or “have” are intended to designate that features, numbers, steps, operations, components, parts, or combinations thereof described in the specification exist, and should be understood as not excluding in advance the existence or possibility of addition of one or more other features, numbers, steps, operations, components, parts, or combinations thereof.

Unless defined otherwise, all terms used herein, including technical or scientific terms, have the same meaning as commonly understood by one of ordinary skill in the art to which the disclosure belongs. Terms such as those defined in commonly used dictionaries should be interpreted as having meanings consistent with the meanings they have in the context of the related art, and are not interpreted in an ideal or excessively formal sense unless explicitly defined in this application.

### (Reference Example 1) Cu Powder Sintered Body

### 1. Preparation of Coin Cell

A half-cell was prepared by sintering 500 nm Cu powder into an electrode with a diameter of 18 mm to be used as a working electrode, and lithium metal with a diameter of 16 mm (thickness of 200 μm) was used as a counter electrode. A coin cell was assembled in a glove box under Ar atmosphere (O₂<1 ppm, H₂O<1 ppm) using a CR2032 model. The half-cell was prepared in the order of case, 18 mm electrode, separator (Celgard 2400), electrolyte (1 M lithium bis(trifluoromethanesulfonyl)imide (LiTFSI) mixed with 2 wt % lithium nitrate (LiNO₃) in 1:1 1,3-dioxolane/1,2-dimethoxyethane (DOL/DME)) 70 μL, 16 mm lithium metal, spacer, wave spring, and cap.

### 2. Evaluation of Half-Cell Charge/Discharge Voltage Profile of Cu Powder Sintered Body Anode

The performance of the electrode was evaluated by conducting charging for 0.5 mAh/cm² under current density conditions of 0.1 mA/cm² using a Cu powder sintered body as a working electrode and lithium metal as a counter electrode.

### 3. Evaluation of Full-Cell Charge/Discharge Performance of Cu Powder Sintered Body Anode

Cell performance was evaluated by conducting charge/discharge under 0.2 C (3.0 to 3.8 V cutoff) conditions using the Cu powder sintered body as the anode and LFP as the cathode.

### (Examples 1 to 5) Secondary Batteries Prepared by Mixing Metallic Glass Powder of Each of Zr—Cu—Ni—Al, Mo—Zr—Co—Si, Mo—Zr—Ti—Si, Ti—Cu—Ni—Zr, and Al—Ni—Y—Co, Zr(OH)₄, and Graphite

### 1. Preparation of Paste

Zr—Cu—Ni—Al metallic glass powder, Zr(OH)₄, graphite paste (Example 1), Mo—Zr—Co—Si metallic glass powder, Zr(OH)₄, graphite paste (Example 2), Mo—Zr—Ti—Si metallic glass powder, Zr(OH)₄, graphite paste (Example 3), Ti—Cu—Ni—Zr metallic glass powder, Zr(OH)₄, graphite paste (Example 4), Al—Ni—Y—Co metallic glass powder, Zr(OH)₄, graphite paste (Example 5) were prepared, and when mixing each metallic glass powder with Zr(OH)₄, the mixture of Cu, Mo, Al and Zr was mixed so that the ratio would be 99:1 at % respectively. And the mixture of metallic glass powder of each of Zr—Cu—Ni—Al, Mo—Zr—Co—Si, Mo—Zr—Ti—Si, Ti—Cu—Ni—Zr, and Al—Ni—Y—Co, Zr(OH)₄ and graphite were mixed so that the ratio would be 90:10 wt %. The mixture of metallic glass powder of each of Zr—Cu—Ni—Al, Mo—Zr—Co—Si, Mo—Zr—Ti—Si, Ti—Cu—Ni—Zr, and Al—Ni—Y—Co, Zr(OH)₄, and graphite and polyethylene glycol (PEG) were put into a paste mixer container at a ratio of 8.5:1.5 wt %. Using a paste mixer, the first condition was set to revolution 1000, resolution 1000, 1 minute, and the second condition was set to revolution 100, resolution 100, 1 minute, and then mixing was performed.

### 2. Preparation of Electrode

Printing was performed using screen masks with circular patterns of 18 mm diameter for half-cells and 16 mm diameter for full-cells. A certain amount of the mixed paste of metallic glass powder of each of Zr—Cu—Ni—Al, Mo—Zr—Co—Si, Mo—Zr—Ti—Si, Ti—Cu—Ni—Zr, and Al—Ni—Y—Co, Zr(OH)₄, and graphite was printed on a substrate using a squeegee on top of the screen mask pattern. The substrate on which the mixed paste of metallic glass powder of each of Zr—Cu—Ni—Al, Mo—Zr—Co—Si, Mo—Zr—Ti—Si, Ti—Cu—Ni—Zr, and Al—Ni—Y—Co, Zr(OH)₄, and graphite was printed was placed in an RTP equipment and processed under vacuum. After purging the inside of the RTP equipment twice under Ar atmosphere, heat treatment was performed while flowing Ar gas at a rate of 70 sccm. Heat treatment was performed at an RTP internal temperature of 250° C. for 5 minutes to vaporize PEG as the solvent, and then heat treatment was performed at 700° C. for 5 minutes to allow sintering to occur between metallic glass powder of each of Zr—Cu—Ni—Al, Mo—Zr—Co—Si, Mo—Zr—Ti—Si, Ti—Cu—Ni—Zr, and Al—Ni—Y—Co, Zr(OH)₄, and graphite powder. When the heat treatment was completed, the printed substrate was removed from the RTP equipment, and then the circular electrode made by sintering was separated from the substrate.

### 3. Preparation of Coin Cell

For half-cells, an electrode with a diameter of 18 mm prepared from mixed paste of metallic glass powder of each of Zr—Cu—Ni—Al, Mo—Zr—Co—Si, Mo—Zr—Ti—Si, Ti—Cu—Ni—Zr, and Al—Ni—Y—Co, Zr(OH)₄, and graphite was used as a working electrode, and lithium metal with a diameter of 16 mm (200 μm thickness) was used as a counter electrode. A coin cell was assembled in a glove box under Ar atmosphere (O₂<1 ppm, H₂O<1 ppm) using a CR2032 model. The half-cell was prepared in the order of case, 18 mm electrode, separator (Celgard 2400), electrolyte (1 M lithium bis(trifluoromethanesulfonyl)imide (LiTFSI) mixed with 2 wt % lithium nitrate (LiNO₃) in 1:1 1,3-dioxolane/1,2-dimethoxyethane (DOL/DME)) 70 μL, 16 mm lithium metal, spacer, wave spring, and cap.

### 4. Evaluation of Half-Cell Charge/Discharge Performance of Anodes Having Composite of Metallic Glass Powder of Each of Zr—Cu—Ni—Al, Mo—Zr—Co—Si, Mo—Zr—Ti—Si, Ti—Cu—Ni—Zr, and Al—Ni—Y—Co, Zr(OH)₄, and Graphite

The overvoltage of electrodes was evaluated by conducting charging for 0.5 mAh/cm² under current density conditions of 0.1 mA/cm² using anodes having a composite of metallic glass powder of each of Zr—Cu—Ni—Al, Mo—Zr—Co—Si, Mo—Zr—Ti—Si, Ti—Cu—Ni—Zr, and Al—Ni—Y—Co, Zr(OH)₄, and graphite as working electrodes and lithium metal as counter electrodes.

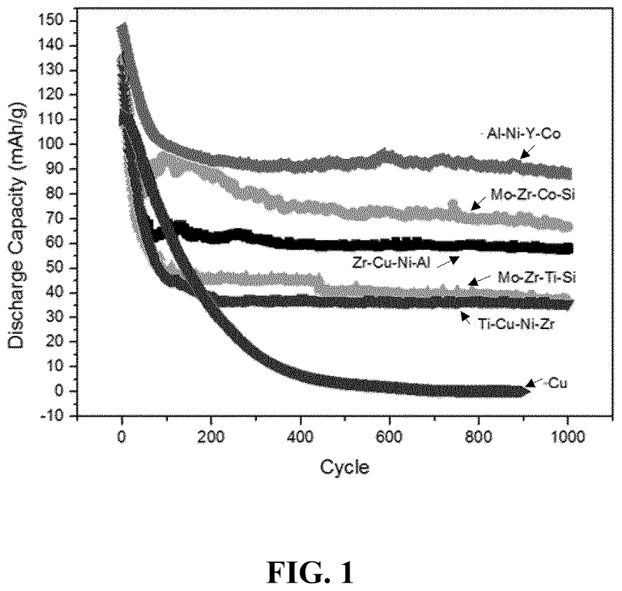

For anodes equipped with a composite of metallic glass powder of each of Zr—Cu—Ni—Al, Mo—Zr—Co—Si, Mo—Zr—Ti—Si, Ti—Cu—Ni—Zr, and Al—Ni—Y—Co, Zr(OH)₄, and graphite, cell performance was compared by mixing one type of metallic glass alloy powder each with Zr(OH)₄ and graphite. As shown in FIG. 1, the x-axis represents charge capacity and the y-axis represents the number of charge/discharge cycles, and the capacity decreased rapidly as the number of cycles of the Cu powder sintered body increased. For the electrodes having the composite of metallic glass powder, Zr(OH)₄, and graphite, the results confirmed that the capacity initially decreased and then stable capacity was maintained up to 1000 cycles.

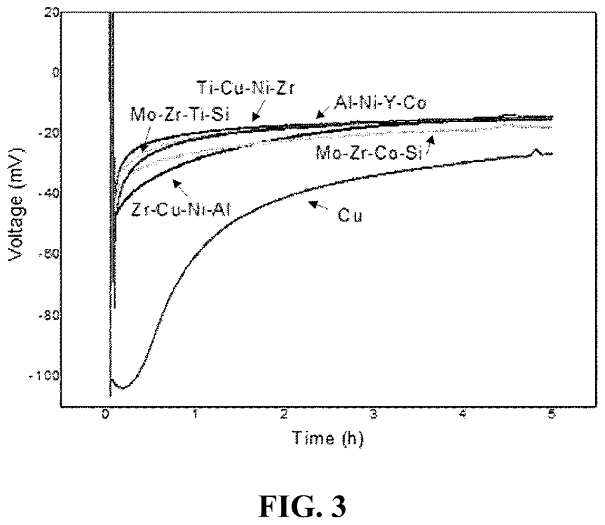

Meanwhile, FIG. 3 is a voltage profile for the charging stage of a copper powder sintered body electrode and a composite electrode of metallic glass powder, Zr(OH)₄ 1 at %, and graphite 10 wt %. As shown in FIG. 3, the x-axis represents capacity and the y-axis represents voltage, indicating nucleation overpotential, and in the charging stage, due to graphite in the electrode, a step occurs due to Li intercalation up to about 0.5 mAh/cm² in the initial charging stage, and after that, a tendency for voltage peaks to appear as Li is deposited on the electrode surface was observed. When compared with a composite anode of Cu 500 nm and graphite 10 wt %, the results confirmed that nucleation overpotential decreased when using metallic glass.

Unless defined otherwise, all terms used herein, including technical or scientific terms, have the same meaning as commonly understood by one of ordinary skill in the art to which the disclosure belongs. Terms such as those defined in commonly used dictionaries should be interpreted as having meanings consistent with the meanings they have in the context of the related art, and are not interpreted in an ideal or excessively formal sense unless explicitly defined in this application.

1. An anodeless lithium secondary battery using a sintered body of amorphous alloy powder or metallic glass powder, comprising:
a cathode;
a current collector positioned facing the cathode and manufactured by sintering a mixture of amorphous alloy powder or metallic glass powder and non-metallic powder;
an electrolyte positioned between the cathode and the current collector; and
a separator separating the cathode and the current collector.

2. An anodeless lithium secondary battery using a sintered body of amorphous alloy powder or metallic glass powder, comprising:
a cathode;
a current collector positioned facing the cathode and manufactured by sintering a mixture of amorphous alloy powder or metallic glass powder;
an electrolyte positioned between the cathode and the current collector; and
a separator separating the cathode and the current collector.

3. The anodeless lithium secondary battery of claim 1,
wherein the metallic glass powder comprises at least two or more different elements, and the metallic glass powder comprises components represented by Formula 1:
$${( Am 1 )}_{n 1} + {( Am 2 )}_{n 1} + {( Am 3 )}_{n 3} + … + {( Amx )}_{ny} \qquad ( Formula 1 )$$
wherein, Am1, Am2, Am3, . . . , Amx represent different metallic glass elements, x is an integer of 2 or more, and n1>0, n2>0, n3≥0, . . . , ny≥0 and n1+n2+ . . . +ny=100 are satisfied.

4. The anodeless lithium secondary battery of claim 3,
wherein the metallic glass powder satisfies enthalpy relationship of Formula 2:
$$Δ {H}_{total} = Δ {H}_{12} + Δ {H}_{13} + Δ {H}_{14} + … + Δ {H}_{1 x} + Δ {H}_{23} + Δ {H}_{24} + … + Δ {H}_{2 x} + Δ {H}_{34} + … + Δ {H}_{3 x} + … + Δ {H}_{( x - 1 ) x} < 0 \qquad ( Formula 2 )$$
wherein, ΔH₍ₓ₋₁₎ₓ represents mixing enthalpy of the Am(x-1) element and the Am(x) element.

5. The anodeless lithium secondary battery of claim 4,
wherein the metallic glass powder is a mixture of two or more types selected from lanthanum (La), cerium (Ce), praseodymium (Pr), promethium (Pm), samarium (Sm), lutetium (Lu), yttrium (Y), neodymium (Nd), gadolinium (Gd), terbium (Tb), dysprosium (Dy), holmium (Ho), erbium (Er), thulium (Tm), thorium (Th), calcium (Ca), scandium (Sc), barium (Ba), beryllium (Be), bismuth (Bi), rubidium (Rb), germanium (Ge), lead (Pb), ytterbium (Yb), chromium (Cr), strontium (Sr), europium (Eu), zirconium (Zr), thallium (Tl), lithium (Li), hafnium (Hf), magnesium (Mg), phosphorus (P), arsenic (As), iron (Fe), palladium (Pd), gold (Au), plutonium (Pu), cobalt (Co), gallium (Ga), tungsten (W), germanium (Ge), silver (Ag), sodium (Na), molybdenum (Mo), nickel (Ni), aluminum (Al), copper (Cu), zinc (Zn), antimony (Sb), silicon (Si), tin (Sn), titanium (Ti), cadmium (Cd), indium (In), platinum (Pt), and mercury (Hg) elements.

6. The anodeless lithium secondary battery using a sintered body of amorphous alloy powder or metallic glass powder of claim 1,
wherein the non-metallic powder is characterized as being selected from one or more of graphite powder, ZrO₂ powder, lithium lanthanum zirconate oxide (LLZO) powder, and solid electrolyte powder.

7. The anodeless lithium secondary battery using a sintered body of amorphous alloy powder or metallic glass powder of claim 1,
wherein the amorphous alloy powder or metallic glass powder is characterized as being partially or entirely crystallized during charge/discharge.

8. The anodeless lithium secondary battery using a sintered body of amorphous alloy powder or metallic glass powder of claim 1,
wherein the electrolyte is characterized as being a liquid electrolyte or a solid electrolyte.

9-10. (canceled)

11. The anodeless lithium secondary battery of claim 2, wherein the metallic glass powder comprises at least two or more different elements, and the metallic glass powder comprises components represented by Formula 1:
$$( Am 1 ) n 1 + ( Am 2 ) n 2 + ( Am 3 ) n 3 + … + ( Amx ) ny \qquad ( Formula 1 )$$
wherein, Am1, Am2, Am3, . . . , Amx represent different metallic glass elements, x is an integer of 2 or more, and n1>0, n2>0, n3≥0, . . . , ny≥0 and n1+n2+ . . . +ny=100 are satisfied.

12. The anodeless lithium secondary battery of claim 11, wherein the metallic glass powder satisfies enthalpy relationship of Formula 2:
$$Δ Htotal = Δ H 12 + Δ H 13 + Δ H 14 + … + Δ H 1 x + Δ H 23 + Δ H 24 + … + Δ H 2 x + Δ H 34 + … + Δ H 3 x + … + Δ H ( x - 1 ) x < 0 \qquad ( Formula 2 )$$
wherein, ΔH₍ₓ₋₁₎ₓ represents mixing enthalpy of the Am(x-1) element and the Am(x) element.

13. The anodeless lithium secondary battery of claim 12,
wherein the metallic glass powder is a mixture of two or more types selected from lanthanum (La), cerium (Ce), praseodymium (Pr), promethium (Pm), samarium (Sm), lutetium (Lu), yttrium (Y), neodymium (Nd), gadolinium (Gd), terbium (Tb), dysprosium (Dy), holmium (Ho), erbium (Er), thulium (Tm), thorium (Th), calcium (Ca), scandium (Sc), barium (Ba), beryllium (Be), bismuth (Bi), rubidium (Rb), germanium (Ge), lead (Pb), ytterbium (Yb), chromium (Cr), strontium (Sr), europium (Eu), zirconium (Zr), thallium (Tl), lithium (Li), hafnium (Hf), magnesium (Mg), phosphorus (P), arsenic (As), iron (Fe), palladium (Pd), gold (Au), plutonium (Pu), cobalt (Co), gallium (Ga), tungsten (W), germanium (Ge), silver (Ag), sodium (Na), molybdenum (Mo), nickel (Ni), aluminum (Al), copper (Cu), zinc (Zn), antimony (Sb), silicon (Si), tin (Sn), titanium (Ti), cadmium (Cd), indium (In), platinum (Pt), and mercury (Hg) elements.

14. The anodeless lithium secondary battery using a sintered body of amorphous alloy powder or metallic glass powder of claim 2,
wherein the amorphous alloy powder or metallic glass powder is characterized as being partially or entirely crystallized during charge/discharge.

15. The anodeless lithium secondary battery using a sintered body of amorphous alloy powder or metallic glass powder of claim 2,
wherein the electrolyte is characterized as being a liquid electrolyte or a solid electrolyte.
